(19) United States
(12) Patent Application Publication
(10) Pub. No.: US 2026/0318471 A1
(43) Pub. Date: Oct. 15, 2026

(54) MODULAR PEDALBOARD ASSEMBLY AND METHODS OF USE THEREOF

(71) Applicant: 52 Sounds LLC, White Rock, NM (US)

(72) Inventor: Akashanand Dighe, White Rock, NM (US)

(21) Appl. No.: 19/467,221

(22) Filed: Feb. 2, 2026

Related U.S. Application Data
(60) Provisional application No. 63/752,515, filed on Jan. 31, 2025.

(51) Int. Cl. F16M 11/22; F16M 11/04; G10H 1/34

(52) U.S. Cl. CPC F16M 11/22; F16M 11/04; G10H 1/348

(57) ABSTRACT

Described herein is a modular pedalboard assembly including a plurality of pedal supports having at least four opposing sides walls, a pedal surface, and a base, each of the opposing side walls of the pedal supports forming a slot configured to accept and secure one end of an adaptor.

### TECHNICAL FIELD

The preset disclosure is generally directed to pedalboard devices, and in particular a modular pedalboard assembly and method of use thereof.

### BACKGROUND

Pedalboard supports, also known as “pedalboards,” are commonly used by musicians to hold one or more effect pedals that can be linked with their instrument to provide different sound effects. Traditional pedalboards generally comprise boards or fixed structures having one or more fixed surfaces for the attachment of pedals to control the electrically amplified musical instrument or electronic instrument. The pedals may be attached by various known methods, such as adhesives, Velcro® type, or the use of a rough surface among others. Typically, a musician will mount the “pedal” on a pedalboard to position the effects in place. Transmission cables are used to link the pedals to a power source and the instrument. Despite near ubiquitous use by, and in particular guitar musicians, traditional fixed pedalboard supports have a number of disadvantages. Firstly, traditional fixed pedalboards are large and difficult to transport, especially where the musician has limited space to store other equipment needed for a performance. Secondly, their surface is fixed by the manufacturer's design, which means that the musician cannot customize the pedal arrangement, or must acquire a much larger pedalboard than is necessary. Thirdly, if the musician needs to enlarge the number of pedals available, in most cases this involves the purchase of new support.

As such, there is a long-felt need for a pedalboard that overcomes the technical deficiencies described above. Specifically, there exists a need for a pedalboard that is modular in nature such that it can be easily broken down, transported, and set up at various locations, and can further be customized to accommodate the desired number and arrangement of pedals.

### SUMMARY OF THE INVENTION

In one aspect, the present disclosure includes systems, apparatus, and methods of manufacturing and using a modular pedalboard assembly. In a preferred aspect, the modular pedalboard assembly of the disclosure includes a pedal support having at least four opposing sides walls, a pedal surface, and a base. Each of the opposing side walls of the pedal support includes a slot configured to accept and secure one end of an adaptor. In this configuration, two or more of the pedal supports can be secured together forming a modular pedalboard assembly by the adaptor secured within the opposing slots on the side walls of the adjacent pedal supports.

In another aspect, the present disclosure includes a kit having a container holding the components necessary to construct a modular pedalboard assembly and instructions for use thereof. In a preferred aspect, the kit of the disclosure includes a plurality of pedal supports, each having at least four opposing sides walls, a pedal surface, and a base, and wherein each of the opposing side walls of the plurality of pedal supports includes a slot. The kit of the disclosure further includes a plurality of adaptors configured to be secured within opposing slots on the side walls of the adjacent pedal supports thereby securing plurality of individual pedal supports in a desired configuration.

In another aspect, the present disclosure includes methods of assembling a modular pedalboard. In a preferred aspect the methods of assembling the modular pedalboard include the steps of positioning a first pedal support adjacent to a second pedal support, wherein each of the supports includes at least four opposing sides walls, a pedal surface, and a base. Next, the first and second pedal supports can be aligned such that a slot on the side wall of each of the supports is adjacent to the other. Once aligned, an adaptor can be inserted into the adjacent slots thereby securing the first and second pedal supports forming a modular assembly unit. In a preferred embodiment, the modular pedalboard assembly can be formed of a plurality of units formed by securing one or more additional pedal supports to the first or second pedal supports via the steps described above until the assembly includes the desired number of coupled pedal support. In this configuration, a user can secure individual pedals to the top surface of the pedal supports in a customized arrangement.

Additional aspects of the present disclosure will become apparent from the specification, drawings, and claims provided below.

### BRIEF DESCRIPTION OF THE FIGURES

FIG. 1: is a perspective view of a modular pedalboard assembly having a plurality of pedal supports coupled via adaptors in series and in parallel in one embodiment thereof;

FIG. 2: is a top view of a modular pedalboard assembly having a plurality of pedal supports each having a pedal surface and coupled via adaptors in series and in parallel in one embodiment thereof;

FIG. 3: is a bottom view of a modular pedalboard assembly having a plurality of pedal supports each having a base and coupled via adaptors having a support column that is approximately flush with the base in series and in parallel in one embodiment thereof;

FIG. 4: is a perspective view of a modular pedalboard assembly having a plurality of pedal supports and coupled via adaptors secured by the slot positions of each pedal support in series and in parallel in one embodiment thereof;

FIG. 5: is a top view of a modular pedalboard assembly having a plurality of pedal supports each having an adhesive secured to the pedal surface and coupled via adaptors in series and in parallel in one embodiment thereof;

FIG. 6A: (A) is a top perspective view of an isolated adaptor having a cross bracket and support column extending along its length in one embodiment thereof; (B) is a side perspective view of an isolated adaptor having a cross bracket and support column extending along its length in one embodiment thereof;

FIG. 7: is a perspective view of an isolated pedal support having slot positioned on its side walls having a lip portion in one embodiment thereof;

FIG. 8: is a perspective view of an adaptor secured within a slot of a pedal support in one embodiment thereof;

FIG. 9: is a side view of two pedal support secured by an adaptor positioned within a slot of each pedal forming a modular pedalboard assembly in one embodiment thereof;

FIG. 10: is a side view of two pedal support secured by an adaptor positioned within a slot of each pedal forming a modular pedalboard assembly in one embodiment thereof;

FIG. 11: is a bottom view of an isolated adaptor having a cross bracket and support column extending along its length with an integral cable channel in one embodiment thereof;

FIG. 12: is a perspective view of an adaptor secured within a first slot of a pedal support and an angular mount secured within a second slot of a pedal support in one embodiment thereof;

FIG. 13: is a perspective view of an isolated angular mount in one embodiment thereof;

FIG. 14: is a perspective view of a modular pedalboard assembly having a plurality of pedal supports and coupled via adaptors secured by the slot positions of each pedal support in series and in parallel and a pair of angled mounts adjacent to slot positions in one embodiment thereof; and

FIG. 15: is a side view of a pair of pedalboard assembly coupled via an adaptor secured by the slot positions and an angled mount secured in a slot position at a top leading edge in one embodiment thereof.

### DETAILED DESCRIPTION OF THE INVENTION

While the disclosure has been particularly shown and described with reference to a number of embodiments, it will be understood by those skilled in the art that changes in form and detail may be made to the various embodiments disclosed herein without departing from the spirit and scope of the disclosure, and that the various embodiments disclosed herein are not intended to act as limitations on the scope of the claims. All references cited herein are incorporated in their entirety by reference.

The terminology used herein is for describing particular embodiments and is not intended to be limiting. As used herein, the singular forms “a,” “an,” and “the” include plural referents unless the context clearly dictates otherwise. Thus, for example, a reference to “a” or “the” reporter may include a combination of two or more such reporters. Unless defined otherwise, all technical terms are to be understood as having the same meaning as commonly used in the art to which they pertain. When used in reference to a list of multiple items, the word “or” is intended to cover all of the following interpretations: any of the items in the list, all of the items in the list, and any combination of items in the list.

As used herein, the terms “pedal” and “pedal device” are generally used to describe associated sound-effect devices and equipment for use in conjunction with the pedalboard and system of the disclosure. Nevertheless, the terms are intended to encompass any sound-effect device comprising controls and adjustment structures for their operation, including a foot-operated button switch, which may or may not contain a hinged pedal structure operable by the user's foot. For instance, sound-effect devices can contain exclusively manually operable knobs and controls, or alternatively include both hand-operated manual controls in combination with a podiatric adjustment structure such as a push button or vertically adjustable conventional foot pedal. The term, as well as the term “equipment” discussed in the same context, is meant to generally refer to connectable devices which are typically positioned at floor level in use, in proximity to and accessible to the user (i.e., musician), including, but not limited to, tuners, delays, reverbs, modulators, compressors, overdrives, equalizers, and the like.

The terms “front” and “rear” or “top” and “bottom,” when used to describe locations of structural features of the pedalboard assembly of the disclosure, are used in reference to the panel board device as placed in relation to the user such that the “front” is oriented away from the user toward an audience, for example, and the “rear” is oriented in closer proximity to and most accessible to the user. Similarly, when sides of the embodiments are referred to with the terms “left” and “right,” the terms are used from the perspective of viewing the device facing forward toward the front from the rear—such being the point of reference from which the terms are used.

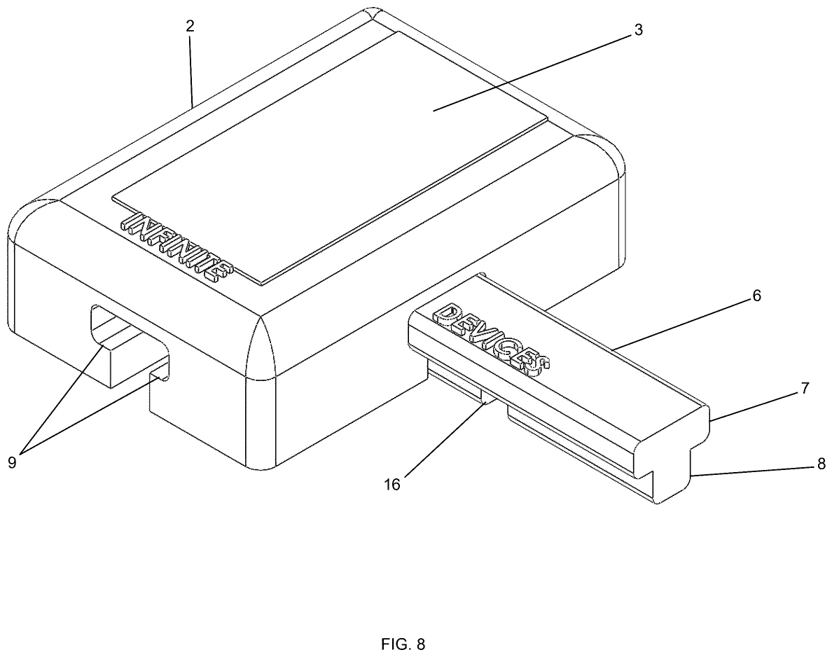

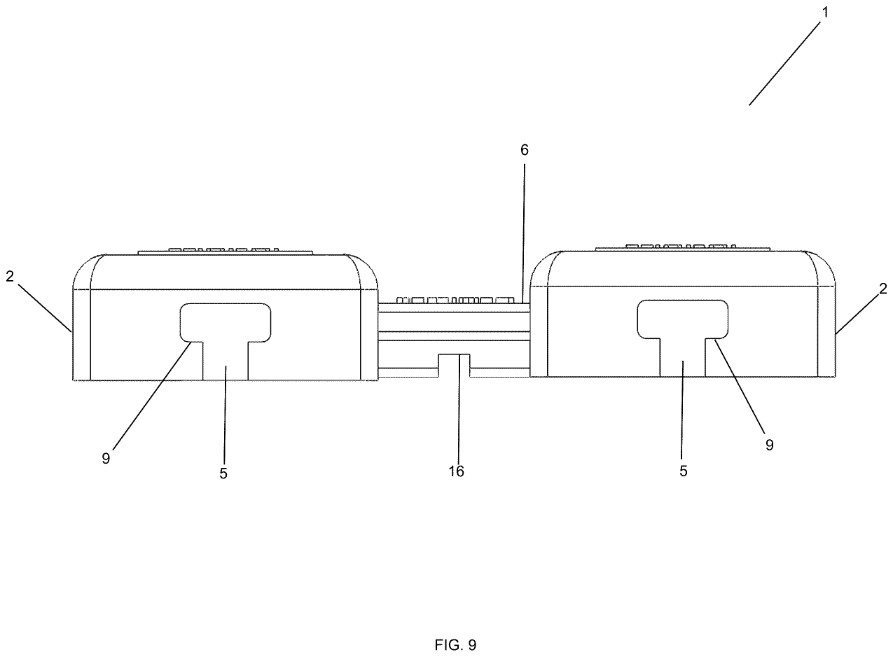

The present disclosure is directed to a modular pedalboard assembly (1) adapted to secure a plurality of effects pedals (10) for use by a musician, and particularly a guitarist. As generally shown in FIG. 8, the modular pedalboard assembly (1) of the disclosure includes one or more modular pedal supports (2) that can be arranged in a variety of configurations according to the needs or desires of the user. In a preferred embodiment, a pedal support (2) of the disclosure can include an approximately rectangular body having at least four opposing side walls, a pedal surface (3), and a base (4).

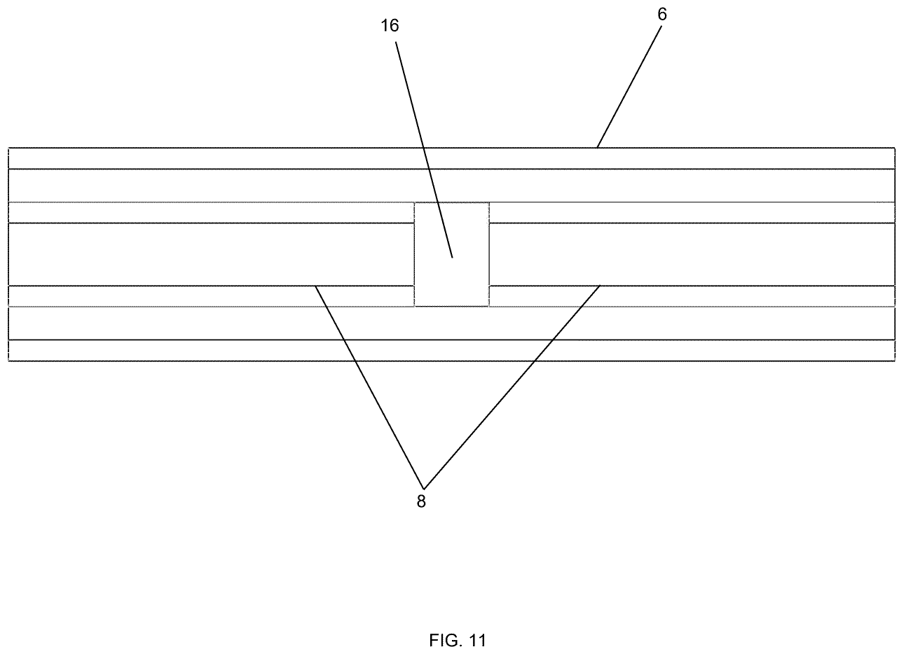

As shown in FIG. 11, an adhesive surface (11) can be secured to the pedal surface (3) and configured to secure a pedal (10). In a preferred embodiment, the adhesive surface (11) can include a channel or roughened surface configured to secure a pedal (10) by generating a high-friction surface. In alternative embodiments, the adhesive surface (11) can include a Velcro® surface configured to secure a pedal (10) to the pedal surface (3), while in still further embodiments, the adhesive surface (11) can include glue, tape, a band, or another tackified surface configured to secure a pedal to the pedal surface (3). In one embodiment not shown, the pedal surface (3) can include a separable or integral coupler configured to mechanically secure a pedal to the pedal surface (3).

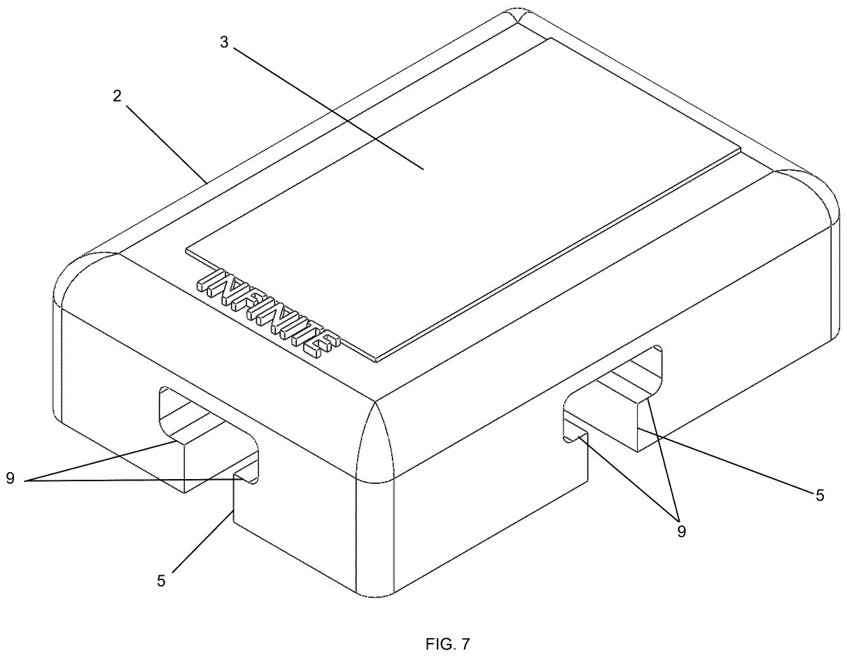

Referring again to FIG. 7, each side wall of a pedal support (2) can include a slot (5) configured to accept and secure one end of an adaptor (6) forming a modular unit. The slot (5) positioned on the side wall of a pedal support (2) can include a shaped cavity adapted to receive a correspondingly shaped adaptor (6). In the preferred embodiment shown in FIGS. 7-8, the slot (5) positioned on the pedal support (2) forms a T-shape having a lip (9) extending the length of the slot (5). In this configuration, the adaptor (6) is configured to have a corresponding T-shape having a cross bracket (7) that is supported by the lip (9) of the slot (5) and a support column (8) that forms a fitted connection with the terminal portion of the adaptor (6). In a preferred embodiment, the adaptor (6) can include a cable channel (16) positioned on the support column (8). In the configuration, when placed on the floor during use, cables, power connectors, or plugs from individual pedals can run through the cable channels (16), which form a network, to be operably linked to a power source.

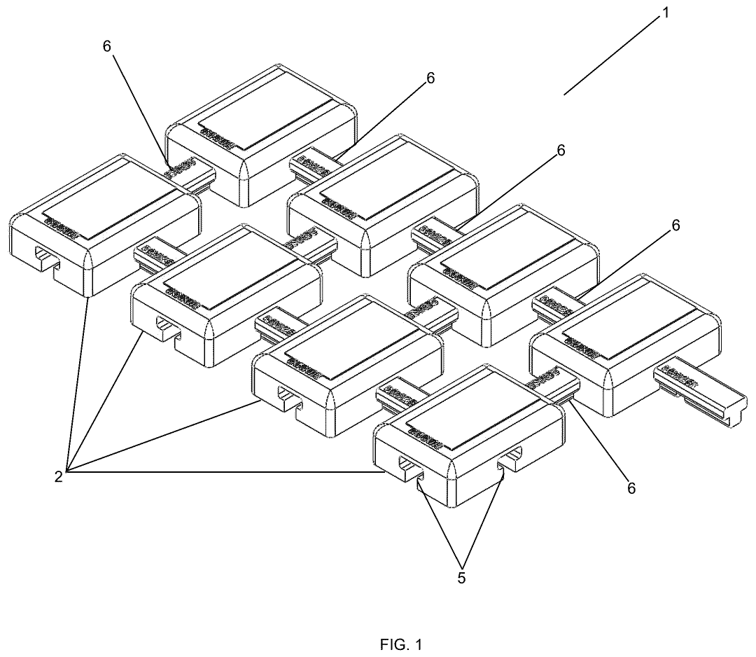

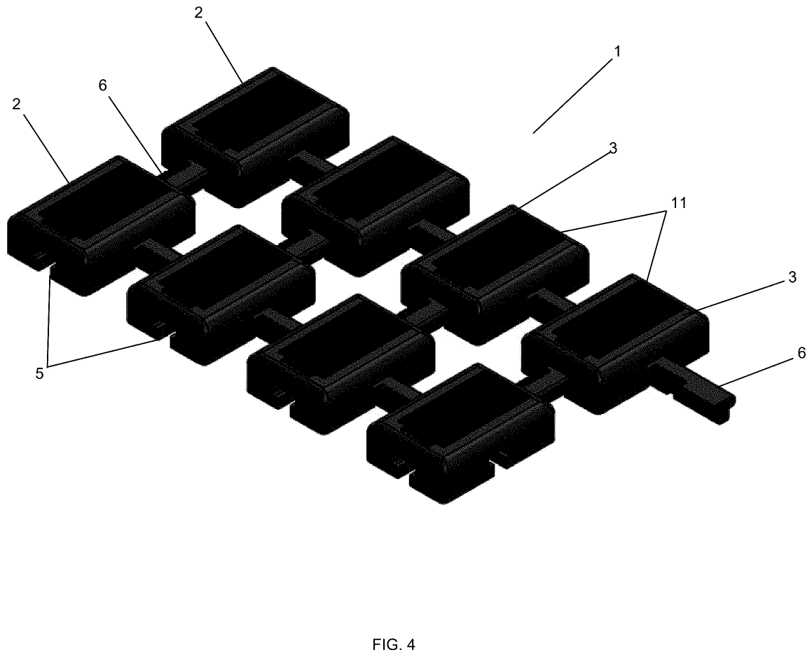

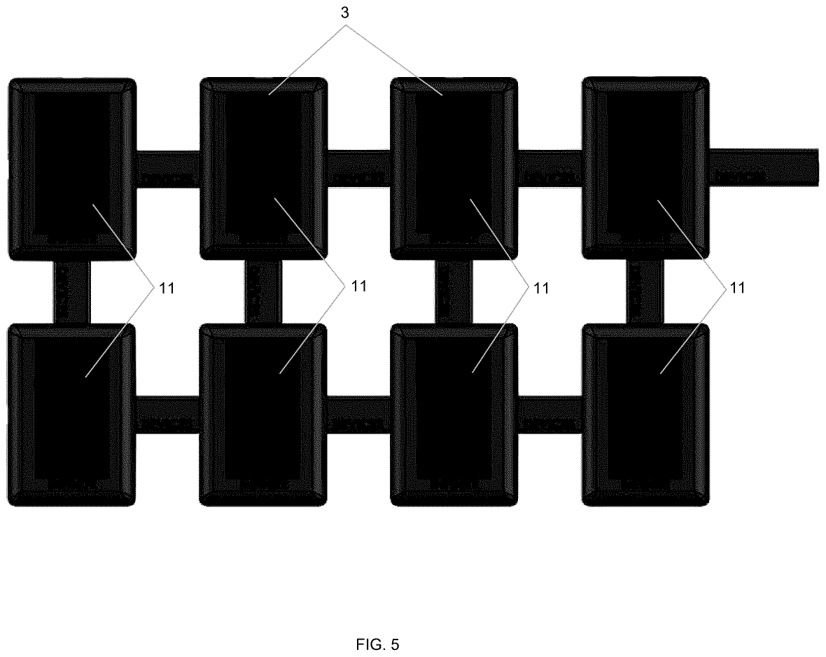

As further shown in FIGS. 1 and 4, the bottom surface of the support column (8) of the adaptor (6) can be approximately flush with the base (4) surface such that the bottom surface of the support column (8) of the adaptor (6) can form part of the base (4) surface. This configuration allows for the bottom portion of the slot(s) (5) of the pedal support (2) to be open, causing the assembly to be lighter and requiring less material during the manufacturing process.

Naturally, the foregoing is only one exemplary embodiment of the connection between the slot (5) and adaptor (6). In additional embodiments, the adaptor (6) can include a mechanical coupler positioned at one or both terminal portions configured to be mated with a coupler receiver positioned on the side wall of the pedal support (2), or within a slot (5). Exemplary couplers can include a snap coupler, a slide coupler, a twist coupler, a quick coupler, or other similar coupling devices known in the art.

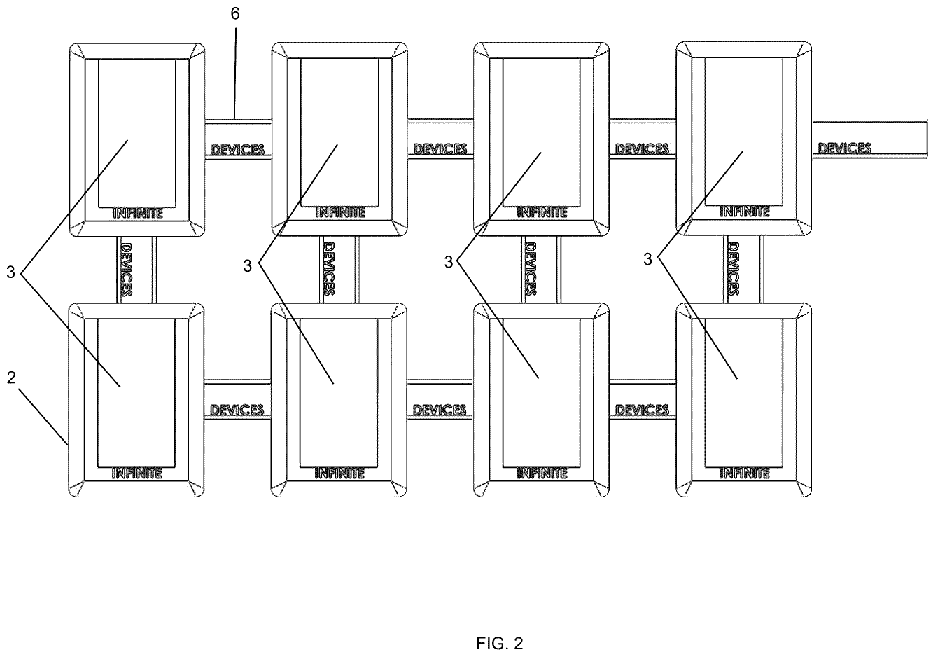

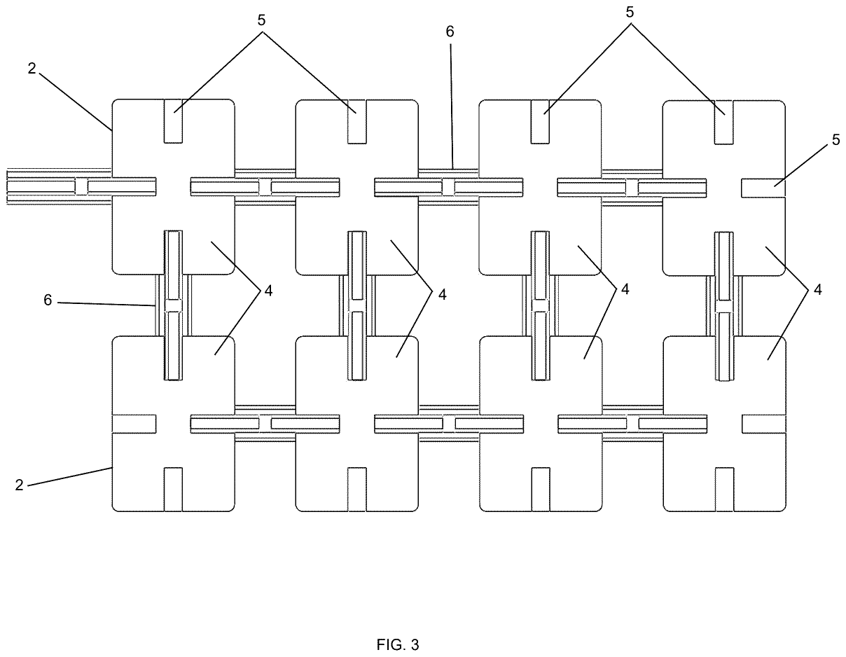

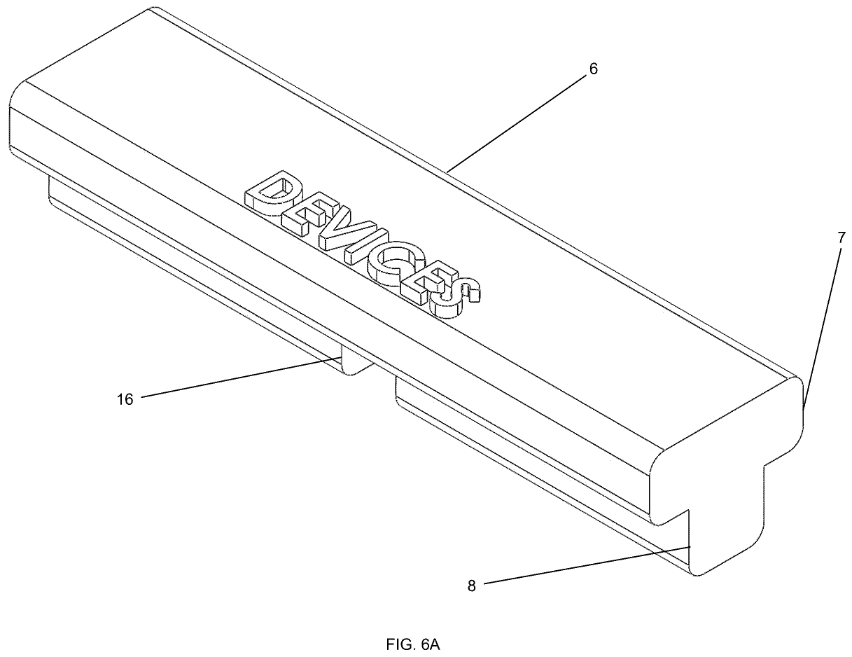

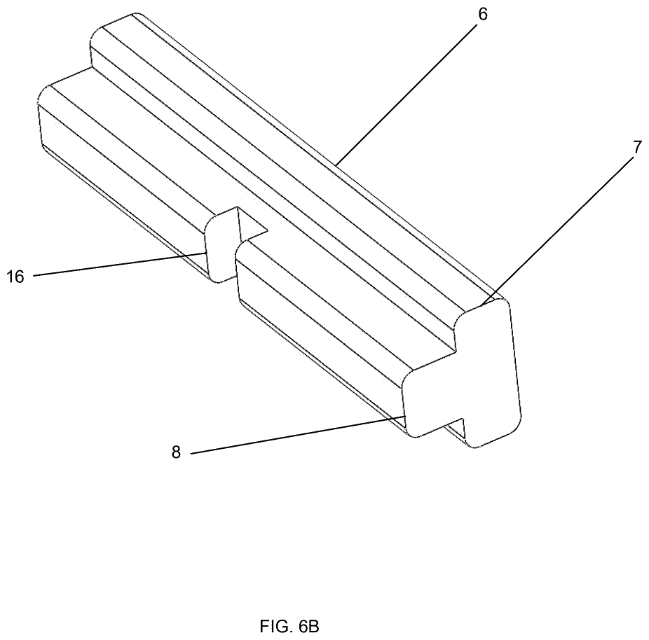

The modular pedalboard assembly (1) can include a variable number of pedal supports (2) interconnected with adaptors (6). In one preferred embodiment, the modular pedalboard assembly (1) can include a plurality of pedal supports (2) secured in series and/or parallel by a plurality of adaptors (6) securing adjacent slot positions on the pedal supports (2). In this modular configuration, the number and position of the pedal supports (2) can be customized by a user based on the number of desired pedals (10) or the space available to deploy the assembly (1). Generally referring to FIGS. 1-5, in one embodiment, the modular pedalboard assembly (1) can include two or more, and preferably between two and twenty, pedal supports (2) secured in parallel and/or in series forming multiple rows of pedals (10).

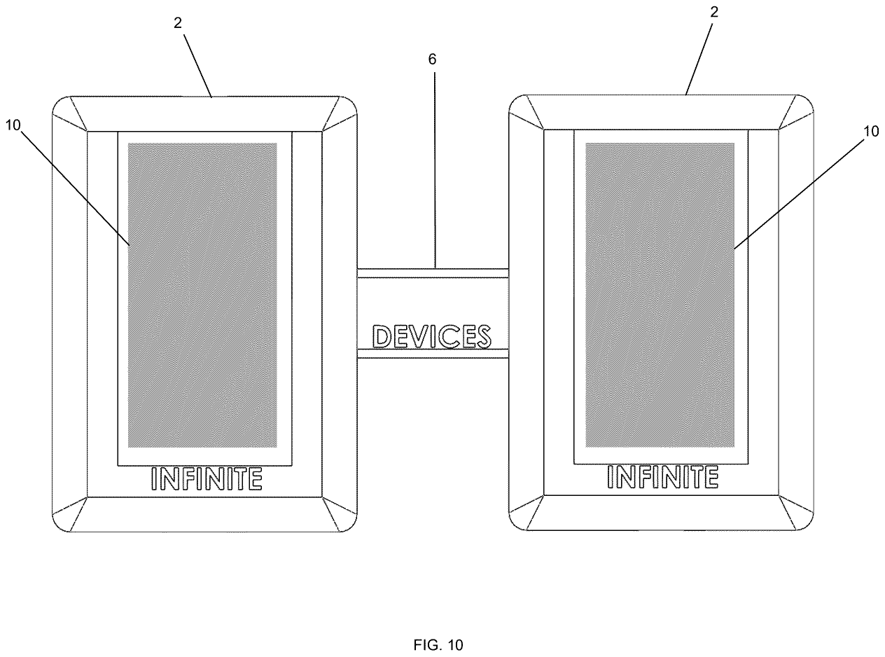

As further shown in FIGS. 1-5, each pedal support (2) within the assembly can be secured by one or multiple adaptors (6). For example, a single row forming the front of the modular pedalboard assembly (1) can include a plurality of pedal supports (2) secured in parallel by cross-linked adaptors (6) secured in adjacent slots (5) positioned on each support (2), while a second row forming the rear of the assembly can be secured in series to the first row by cross-linked adaptors (6) secured in adjacent slots (5) positioned on each support (2). Additional adaptors (6) can be used to crosslink the pedal supports (2) based on a user's desire or need. As further shown in FIG. 10, the length and depth of the adaptor (6) can also be variable so that the space between the pedal supports (2) can be customized to accommodate cords and electronic plugs which are often positioned such that they cannot be easily accommodated on traditional pedalboards.

The pedalboard assembly (1) can further be provided in a kit having a container, such as a bag or other storage container, holding the components necessary to construct a modular pedalboard assembly (1) and instructions for use thereof. In a preferred embodiment, the kit of the disclosure includes a plurality of pedal supports (2), each having at least four opposing side walls, a pedal surface (3), and a base (4), and wherein each of the opposing side walls of the plurality of pedal supports (2) includes a slot (5). The kit of the disclosure further includes a plurality of adaptors (6) configured to be secured within opposing slots (5) on the side walls of adjacent pedal supports (2), thereby securing the plurality of individual pedal supports (2) in a desired configuration, for example as shown in FIGS. 1-5 and 11.

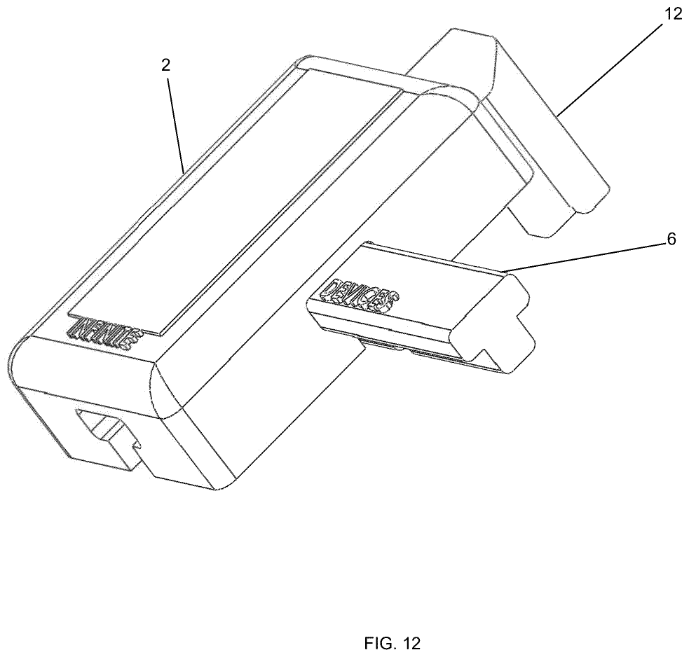

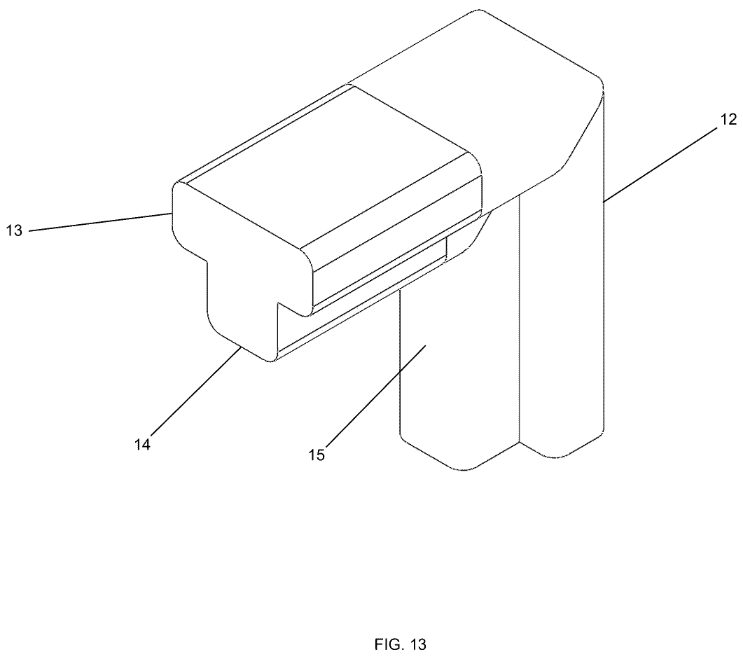

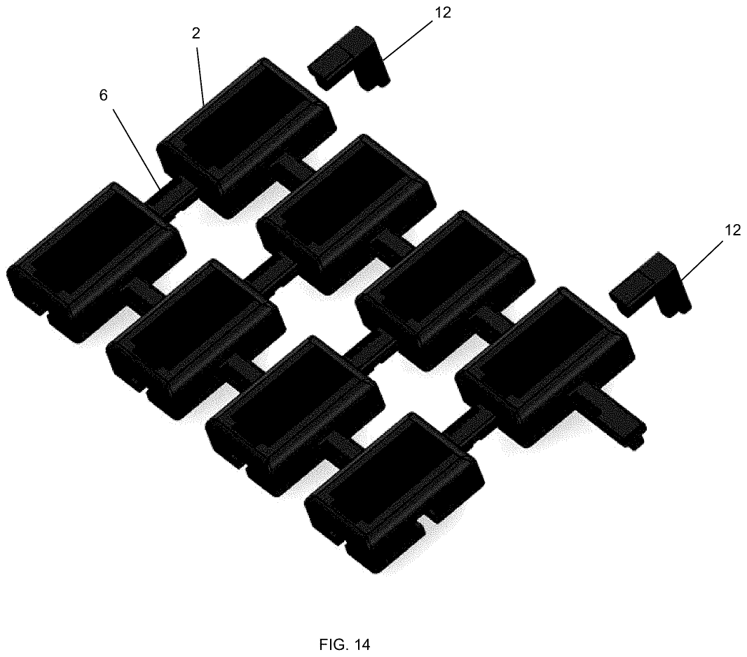

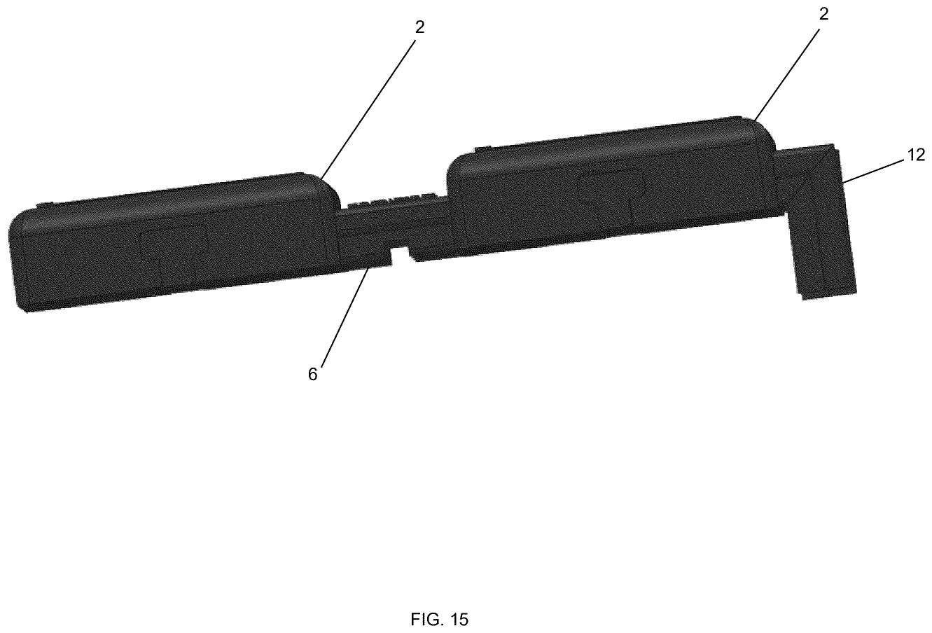

The present invention can include one or more angled mounts (12). As shown in FIGS. 12-15, in one preferred embodiment an angled mount (12) can be configured to be secured within a slot (5) of the pedal support (2). In this configuration, a mount bracket (13) is configured to be secured in the slot (5) position, while mount extensions (14) on either side of the mount bracket (13) are supported by a corresponding lip (9) of the slot (5). As shown in FIG. 13, a mount guide (15) can be positioned on the underside of the angled mount (12) and continuous with the mount extension (14). In this configuration, the mount guide (15) can be inserted into the slot (5) of the pedal support (2). Again, referring to FIG. 15, in a preferred embodiment, one or more angled mounts (12) can be inserted into and secured in the slot (5) positions of one or more pedal supports (2) positioned along the top of the modular pedalboard assembly (1). In this configuration, the top edge of the modular pedalboard assembly (1) is secured at an angular position relative to a user positioned in front of the assembly with the bottom leading edge positioned on the ground. This angled configuration allows for easier access and control by a user to the modular pedalboard assembly (1) while in use, while maintaining full modularity. Naturally, different lengths of angled mounts (12) can be employed to provide for a steeper angle of the assembly relative to the user.

The modular pedalboard assembly (1) of the disclosure can be manufactured using a variety of materials. In certain embodiments, the adaptor (6) and pedal support (2) can be made from a lightweight, rigid material, such as plastic or thermoplastic compositions. In a preferred embodiment, the adaptor (6) and pedal supports (2) that form the modular pedalboard assembly (1) can be manufactured by additive or subtractive 3D-printing processes which are known to those of ordinary skill in the art.

The present disclosure further describes a method of assembling a modular pedalboard. In one embodiment, the modular pedalboard assembly (1) can be assembled by a user through the selective positioning and coupling of a plurality of pedal supports (2) and adaptors (6). Each pedal support (2) includes at least four opposing side walls, a pedal surface (3), and a base (4), and each side wall includes at least one slot (5) configured to receive an adaptor (6).

In a preferred method of assembly, a first pedal support (2) is positioned adjacent to a second pedal support (2). The user aligns the supports such that a slot (5) on a side wall of the first pedal support (2) is adjacent to a corresponding slot (5) on the second pedal support (2). An adaptor (6) is then inserted into the adjacent slots (5) to secure the first and second pedal supports (2), thereby forming a modular assembly unit. In embodiments in which each slot (5) defines a T-shaped cavity with a lip (9), the adaptor (6) can be positioned such that the cross bracket (7) rests on the lip (9) and the support column (8) is received within the shaped portion of the slot (5). The adaptor (6) can be positioned into place until a secure mechanical coupling is achieved.

The user may expand the assembly by positioning one or more additional pedal supports (2) adjacent to the previously coupled supports (2) and repeating the alignment and adaptor-insertion steps described above. In this manner, the modular pedalboard assembly (1) can be expanded horizontally, vertically, or in mixed configurations depending on performance needs or available space. Rows of pedal supports (2) can be formed in parallel, while additional rows can be connected in series through the use of additional adaptors (6). Adaptors (6) of varying lengths or depths may be used to adjust spacing between pedal supports (2), for example to accommodate cables, power connectors, or plugs extending from pedals (10). In a preferred embodiment, the adaptor (6) can include a cable channel (16) positioned on the support column (8). In the configuration, when placed on the floor during use, cables, power connectors, or plugs from individual pedals can run through the cable channels (16), which form a network, to be operably linked to a power source.

If angled mounts (12) are to be integrated into the assembly, the user may insert one or more angled mounts (12) into desired slots (5) of selected pedal supports (2). In such embodiments, the mount bracket (13) can be secured within the slot (5), while mount extensions (14) rest upon the lip (9) of the slot. A mount guide (15), when present, may further stabilize the angled mount (12) by engaging the slot (5). When one or more angled mounts (12) are installed along the upper row of pedal supports (2), the top row of the modular pedalboard assembly (1) can be elevated to create an inclined configuration relative to the user. Once assembled, the user may check the overall alignment and rigidity of the assembly. The modular nature of the system allows for rapid reconfiguration by removing or repositioning adaptors (6), adding or removing pedal supports (2), or adjusting spacing as needed.

After assembling the desired arrangement of pedal supports (2), the user can mount pedals (10) onto the pedal surfaces (3). In one embodiment, the pedal surface (3) includes an adhesive surface (11), such as a friction-generating texture, a roughened surface, a Velcro® interface, or another tackified or mechanically engaging surface. A pedal (10) can be pressed onto the adhesive surface (11) until sufficient engagement is achieved to maintain positional stability during operation.

In embodiments where the pedal surface (3) includes a mechanical coupler, the pedal (10) can be aligned with and secured to the coupler by snap action, sliding engagement, twisting engagement, or other mechanical connection techniques. The modularity of the pedal supports (2) allows pedals (10) to be mounted in numerous configurations, including linear, staggered, offset, or mixed arrangements.

The method of assembly further includes the step of securing a desired number and type of pedals (10) to the pedal surfaces (3) of the assembled pedal supports (2) in any arrangement suitable for the user. Pedal mounting may occur either after the assembly of the pedalboard or concurrently, depending on user preference.

In use, the fully assembled modular pedalboard assembly (1) may be deployed on a flat surface such as a stage floor, rehearsal room, performance space, or recording studio. The “front” or “top” of the assembly is oriented away from the user, while the “rear” or “bottom” is positioned closer to the user for optimal access to controls. Pedals (10) mounted to the pedal supports (2) can be connected with patch cables, power supplies, or other interconnects. Variable spacing between pedal supports (2), enabled by adaptors (6) of different lengths, can accommodate plugs or connectors that extend downward, upward, or sideways from the pedals (10), overcoming limitations common to conventional fixed-surface pedalboards.

In embodiments using angled mounts (12), the upper row of pedals (10) may be inclined toward the user, thereby improving visibility, ergonomic access, and operational efficiency during performance. The user can activate or deactivate pedals (10) by foot operation of switches or hinged pedal structures without compromising the structural integrity of the modular pedalboard assembly (1).

The modular nature of the assembly further allows a user to change the configuration before, during, or after use. Pedal supports (2) may be removed or rearranged, and angled mounts (12) may be repositioned to provide different incline geometries based on user preference or performance requirements.

Finally, any or all of the assembly steps described herein can be reversed to remove pedals (10) from the pedal supports (2) and to disassemble the modular pedalboard assembly (1) into its individual components for storage or transport. The components may be placed in a carrying case, bag, or other container included with certain embodiments.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish a modular pedalboard assembly and the like. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention may be described in some instances in method-oriented terminology, each element of the claims corresponds to a device and vice versa. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “supporting method and/or technique, and/or device” and even a “means for supporting.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing a modular pedalboard assembly as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

References to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

Finally, Applicant reserves the right to seek additional design patent protection over the claimed invention, such that the drawings are fully enabled so as to allow one of ordinary skill in the art to know that the claimed design was in Applicant's possession at the time of filing.

What is claimed is:

1. A modular pedalboard assembly comprising:
a pedal support having at least four opposing sides walls, a pedal surface, and a base;
wherein each of the opposing side walls of the pedal support includes a slot configured to accept and secure one end of an adaptor; and
wherein two or more of the pedal supports are secured together forming a modular pedalboard assembly by the adaptor secured within the opposing slots on the side walls of the adjacent pedal supports.

2. The assembly of claim 1, wherein said pedal surface further comprises an adhesive surface.

3. The assembly of claim 2, wherein said adhesive surface comprises a Velcro® surface configured to secure one or more pedals to the pedal surface.

4. The assembly of claim 1, wherein said adaptor comprises a cross bracket portion and a support column portion.

5. The assembly of claim 4, wherein each of the slots comprises a lip configured to support the bracket portion of the adaptor.

6. The assembly of claim 1, wherein said support column portion is approximately flush with the base of the support pedal.

7. The assembly of claim 1, wherein said plurality of the pedal supports are secured together in series and in parallel by two or more adaptors secured within the opposing slots on the side walls of the adjacent pedal supports.

8. The assembly of claim 1 or 7, wherein said plurality of the pedal supports comprises between 2-20 pedal supports coupled in series and/or parallel by one or more adaptors forming a modular pedalboard assembly.

9. The assembly of claim 8, wherein said one or more adaptors comprises between 1-28 adaptors coupled in series and/or parallel forming a modular pedalboard assembly.

10. The assembly of any of claims 1-9, wherein said pedal supports comprises 3D printed pedal supports.

11. The assembly of any of claims 1-9, wherein said adaptors comprises 3D printed adaptors.

12. A method of assembling a modular pedalboard comprising:
positioning a first pedal support adjacent to a second pedal support, wherein each of the supports includes at least four opposing sides walls, a pedal surface, and a base;
aligning the first and second pedal supports such that a slot on the side wall of each of the supports is adjacent to the other;
inserting an adaptor into the adjacent slots thereby securing the first and second pedal supports forming a modular assembly; and
optionally expanding the modular pedalboard assembly by securing one or more additional pedal supports to the first or second pedal supports via the steps described above until the assembly includes the desired number of the pedal supports being interconnected by the plurality of adaptors.

13. The method of claim 12, further comprising placing an adhesive surface on each of the pedal support.

14. The method of claim 13, wherein said adhesive surface comprises a Velcro® surface configured to secure one or more pedals to the pedal surface.

15. The method of claim 12, wherein said adaptor comprises a cross bracket portion and a support column portion.

16. The method of claim 15, wherein each of the slots comprise a lip configured to support the bracket portion of the adaptor.

17. The method of claim 12, wherein said support column portion is approximately flush with the base of the support pedal.

18. The method of claim 12, wherein said step of expanding the modular pedalboard assembly comprises the step of securing a plurality of the pedal supports together in series and in parallel by two or more adaptors secured within the opposing slots on the side walls of the adjacent pedal supports.

19. The method of claim 12 or 18, wherein said plurality of the pedal supports comprises between 2-20 pedal supports coupled in series and/or parallel by one or more adaptors forming a modular pedalboard assembly.

20. The method of claim 19, wherein said one or more adaptors comprises between 1-28 adaptors coupled in series and/or parallel forming a modular pedalboard assembly.

21. The method of any of claims 12-20, wherein said pedal supports comprises 3D printed pedal supports.

22. The method of any of claims 12-20, wherein said adaptors comprises 3D printed adaptors.

23. A modular pedalboard assembly kit comprising:
a plurality of pedal supports, each having at least four opposing sides walls, a pedal surface, and a base, and wherein each of the opposing side walls of the plurality of pedal supports includes a slot;
a plurality of adaptors;
wherein said plurality of the pedal supports are secured together in series and in parallel by two or more adaptors secured within the opposing slots on the side walls of the adjacent pedal supports; and
a container holding the plurality of pedal supports and the adaptors, and instructions for use thereof.

24. The kit of claim 23, further comprising an adhesive surface.

25. The kit of claim 24, wherein said adhesive surface comprises a Velcro® surface configured to secure one or more pedals to the pedal surface.

26. The kit of claim 23, wherein each of the adaptors comprise a cross bracket portion and a support column portion.

27. The kit of claim 26, wherein each of the slots comprises a lip configured to support the bracket portion of the adaptor.

28. The kit of claim 23, wherein said support column portion is approximately flush with the base of the support pedal.

29. The kit of claim 23, wherein said plurality of the pedal supports comprises between 2-20 pedal supports coupled in series and/or parallel by one or more adaptors forming a modular pedalboard assembly.

30. The kit of claim 29, wherein said one or more adaptors comprises between 1-28 adaptors coupled in series and/or parallel forming a modular pedalboard assembly.

31. The kit of any of claims 23-30, wherein said pedal supports comprises 3D printed pedal supports.

32. The kit of any of claims 23-30, wherein said adaptors comprises 3D printed adaptors.
